(19) United States
(12) Patent Application Publication
(10) Pub. No.: US 2004/0236692 A1
(43) Pub. Date: Nov. 25, 2004

(54) Authorization approved transaction

(76) Inventors: Kerry Sellen, Kemah, TX (US); Chris Schmid, Houston, TX (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/821,408

(22) Filed: Apr. 9, 2004

Related U.S. Application Data
(60) Provisional application No. 60/462,564, filed on Apr. 11, 2003.

(51) Int. Cl. G06F 17/60

(52) U.S. Cl. 705/45; 705/42; 705/39

(57) ABSTRACT

The routing of monetary funds may be achieved via electronic check conversion technology where paper drafted checks are converted to an electronic format. A particular financial institution due to unrecognizable identification information submitted with the electronic check may reject electronic checks. Most merchant related businesses, including check approval agencies, fail to pre-process electronic checks to avoid likely rejections from the financial institutions. The present teachings relates to a method of preprocessing various electronic payments to determine the most efficient routing of funds available.

### CLAIM OF PRIORITY

This application is a non-provisional application of and claims priority to U.S. Provisional Patent Application No. 60/462,564 filed Apr. 11, 2003, entitled “AUTHORIZATION APPROVED TRANSACTION” (Attorney Docket No. 1DATA.061APR), which is hereby incorporated by reference herein in its entirety.

### BACKGROUND OF THE INVENTION

1. Field of the Invention

The present invention relates to financial transactions and, in particular, to a method of preprocessing financial data so as to increase transaction efficiency.

2. Description of the Related Art

A typical financial transaction involves a form of payment in exchange for goods and services at a point of sale. In some instances, a customer provides a paper drafted check as a form of payment to a merchant at a point of sale in exchange for the goods and services. The paper drafted check may be regarded as a non-cash promissory payment that instructs the customer's financial institution to transfer monetary funds from the customer's account to the merchant by the amount indicated on the paper drafted check. Unfortunately, paper drafted checks often involve long processing times, such as several days for payment settlement, which delays the use of capital for business related expenses. The processing times occur, to a large extent, due to the time it takes to physically transport the paper check to the merchant's financial institution and from the merchant's financial institution to the federal clearing house for eventual transfer of funds from the customer's financial institution to the merchant's bank. In some instances, the merchant may be reluctant to accept paper drafted checks as payment for goods and services due to the associated settlement delay involved in accepting paper drafted checks.

As a result of the associated settlement delay with paper drafted checks, the National Automated Clearing House Association (NACHA) has developed an alternative method of payment submission entitled electronic payment or electronic check conversion including guidelines and operating rules. In general, electronic check conversion is a process where a paper drafted check may be utilized as a source of information to generate an electronic check that identifies transaction information including, for example, the routing transit number, the customer's account number, check number, payment amount, and various other customer identification information. This information, in some instances, may be keyed, stamped, scanned, or swiped from the original paper check and is converted into an electronic format. The source of information retained by the electronic check may then be used to request an electronic debit of funds of the indicated amount from the customer's account to the merchant in a manner such that the paper drafted check itself may not be considered the actual method of payment. The near instantaneous transfer of electronic information greatly speeds up the settlement process.

Although electronic check conversion improves cash flow through faster clearing and settlement, it may be expensive to implement for some merchants. Smaller merchants may not be able to directly access the electronic check conversion feature of the federal clearing house as the transaction costs may be too high to justify being able to directly submit the electronic checks to the clearing house or access may not be available to non-financial institutions. Therefore, merchants often subscribe to a check acceptance agency, such as TeleCheck™, that coordinates electronic check related financial transactions with the Federal Reserve on behalf of the merchant.

For a given financial transaction, a subscribed merchant may send an electronic check to the check acceptance agency with identifiable transaction information. Typically, after receiving the electronic check, the check acceptance agency attempts to settle payment with the customer's bank via the electronic check conversion feature of the federal clearing house. The financial information identifying the customer's bank, bank branch, account number, amount to be transferred as well as the merchant's bank, bank branch and account number are all generally electronically sent by the check acceptance agency to the electronic check conversion system of the federal clearing house. This information is then used by the federal clearing house to instruct the customer's bank to transfer the appropriate amount of funds out of the customer's bank account into the merchant's bank account.

However, in many circumstances, the information provided to the electronic check conversion system is not recognizable or identifiable. For example, not all financial institutions participate in the electronic check conversion component of the federal clearing house. Even among participating financial institutions, not all branches are participating or the identification numbers of particular financial institutions or branches of financial institutions are not recognized by the electronic check conversion system of the federal clearing house. Hence, some electronic checks will not be processed by the federal clearing house and returned to the check acceptance agency after a period of time.

The check acceptance agency may then use an alternative method of settling the transaction. For example, the check acceptance agency may then re-create a paper check from the electronic information, particularly if the original paper check written by the customer was scanned or swiped, and submit a paper copy of the check to the clearing house in the normal manner. In many instances, the paper created check may ultimately clear as the customer's bank may recognize the paper check and process it appropriately. Hence, the check acceptance agency in many instances may be successful in using an alternative route for settling the transaction.

Unfortunately, the delays associated with first trying the electronic check conversion route to settle a transaction, receiving a rejection after a delay, and then subsequently trying an alternative route to settle the transaction can be costly. Each unsuccessful attempt to settle a transaction using the electronic check conversion component of the federal clearing house costs time and money for the check acceptance agency. Moreover, the delays in settling the transaction raises the risk that when the transaction request finally reaches the customer's bank, the customer's bank account will have insufficient funds or still be open.

From the foregoing, it will be appreciated that there is a need for a process by which the check acceptance agency can more efficiently settle electronic check transactions. To this end, there is a need for the check acceptance agency to be able to identify which electronic checks are likely to be difficult to settle and be able to prospectively select a transaction route that is more likely to result in favorable settlement of the transaction.

### SUMMARY OF THE INVENTION

The aforementioned needs may be satisfied by a method of processing electronic promissory payments made by a customer to a merchant. In one embodiment, the method comprises receiving an electronic representation of a promissory payment that includes an identification of the customer account and the merchant and determining whether the payment can be submitted for subscriber settlement by evaluating a special rules database to determine whether the customer's transactions are subject to a special rule. In addition, the method comprises submitting the payment to the customer's financial institution electronically if it is determined that the customer's electronic representation is not subject to a special rule and submitting the payment to the customer's financial institution according to the special rule if it is determined that the customer's electronic representation is subject to a special rule.

In one aspect, evaluating the special rules database includes identifying the customer's financial institution associated with at least one of an account number, a routing number, and an alternative routing number. Additionally, evaluating the special rules database includes determining if the special rule comprises printing the electronic representation of the payment as a paper drafted check for submission to the clearing house. Submitting the payment to the customer's financial institution includes submitting the paper drafted check to the customer's financial institution. Submitting the payment to the customer's financial institution includes submitting a pre-authorized check (PAC) item. Also, evaluating the special rules database may include determining if the special rule comprises submitting the electronic representation of the payment to the customer's financial institution via a direct electronic access system. Submitting the payment to the customer's financial institution includes submitting the electronic representation of the payment to the customer's financial institution via the direct electronic access system.

In another aspect, evaluating the special rules database includes determining if the special rule comprises the use of an alternative routing transit number. Submitting the payment includes submitting the payment to the customer's financial institution using the alternative routing transit number. Evaluating the special rules database includes determining if the special rule comprises the use of an alternative account number. Submitting the payment includes submitting the payment to the customer's financial institution using the alternative account number. Receiving electronic promissory payments comprises generating an electronic profile relating to the customer using electronic check conversion. Submitting the customer's electronic representation to the customer's financial institution comprises transferring funds from the customer's account using electronic fund transfer. Submitting the customer's electronic representation to the customer's financial institution comprises transferring funds from the customer's account through a direct connect for On-Us items.

In still another aspect, the method may further comprise performing a risk assessment relating to processing electronic promissory payments using the electronic representations of the promissory payments. In addition, the method may still further comprise updating the special rules database in a manner so as to record previous submissions by the customer.

The aforementioned needs may also be satisfied by a method of settling a financial transaction between a customer and a merchant using a routing mechanism. In one embodiment, the method comprises acquiring an electronic profile relating to the customer, wherein the electronic profile can be used to transfer funds from the customer's financial institution and evaluating the electronic profile using a special rules database having previously stored electronic information relating to the customer in a manner so as to identify a special rule. In addition, the method comprises requesting settlement of the financial transaction with the customer's financial institution using at least one of the electronic profile and the special rule, wherein the special rule identifies the manner in which the funds can be transferred from the customer's financial institution.

The aforementioned needs may also be satisfied by a system for resolving an electronic check transaction to transfer money from a customer's financial institution via an existing funds transfer entity in response to the customer providing a promissory payment to a merchant. In one embodiment, the system comprises a transaction device which receives a promissory payment from the customer to the merchant, wherein the transaction device generates and transmits an electronic profile indicative of the promissory payment and routing information. In addition, the system comprises a check approval service that has access to records of past electronic check transactions that receives the electronic profile, wherein the check approval service identifies an electronic route for obtaining access to the customer's account and either (i) submits the electronic profile to the existing funds transfer entity electronically for electronic transfer of the funds from the customer's account, or (ii) initiates an alternative resolution strategy prior to submitting the electronic profile to the existing funds transfer entity electronically if the records of past electronic check transactions indicates that an electronic check transaction for the received electronic profile may not be successful.

The aforementioned needs may also be satisfied by a method for resolving an electronic check transaction to transfer money from a customer's financial institution via an existing funds transfer entity in response to the customer providing a promissory payment. In one embodiment, the method comprises receiving a promissory payment from the customer, generating an electronic profile indicative of the promissory payment, and transmitting the electronic profile. In addition, the method comprises accessing records of past electronic check transactions and identifying routing information for obtaining access to the customer's account. Moreover, the method comprises submitting the electronic profile to the existing funds transfer entity electronically for electronic transfer of funds from the customer's financial institution if it is determined that the records of past electronic check transactions indicates that an electronic check transaction for the received electronic profile will be successful and initiating an alternative resolution strategy prior to submitting the electronic profile to the existing funds transfer entity electronically if it is determined that the records of past electronic check transactions indicates that an electronic check transaction for the received electronic profile may not be successful.

These and other aspects, advantages, and novel features of the invention will become apparent upon reading the following detailed description and upon reference to the accompanying drawings. In the drawings, similar elements have similar reference numerals.

### BRIEF DESCRIPTION OF THE DRAWINGS

FIG. 1 illustrates one embodiment of a financial transaction involving a customer, a merchant, and a check approval agency or service having a special rules database.

FIG. 2 illustrates one embodiment of a special rules database having a plurality of electronic profiles related to a plurality of customers.

FIG. 3 illustrates one embodiment of a financial transaction process.

FIG. 4 illustrates one embodiment of a check approval process.

FIG. 5 illustrates one embodiment of a special rules retrieval process.

FIG. 6 illustrates one embodiment of an administration process.

### DETAILED DESCRIPTION OF THE PREFERRED EMBODIMENT

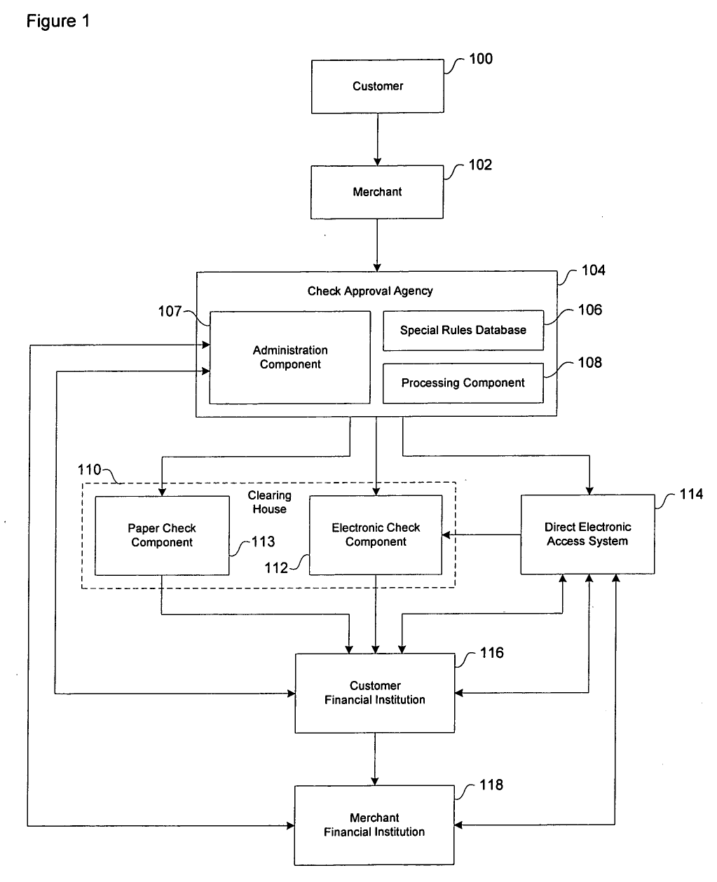

Reference will now be made to the drawings, wherein like numerals refer to like parts throughout. FIG. 1 illustrates one embodiment of a financial transaction involving a customer 100, a merchant 102, and a check approval agency or service 104 having a special rules database 106, an administration component 107, and a processing component 108. FIG. 1 further illustrates a plurality of financial institutions that may be involved in the financial transaction including a clearing house 110, such as a check clearing house, Federal Clearing House (FCH), Automated Clearing House (ACH), or various other banking institutions including an On-Us Bank and an ATM Bank, having an electronic check component 112 and a paper check component 113, a direct electronic access system 114, a customer financial institution 116, and a merchant financial institution 118. In general, it should be appreciated that the financial institutions, as described herein below, may be referred to as financial entities, banks, banking institutions, organizations, systems, networks, etc. without departing from the scope of the present teachings.

In one embodiment of the financial transaction, the customer 100 provides a paper drafted check or promissory payment to the merchant 102 in exchange for goods, merchandise, and/or services. The paper drafted check is accepted by the merchant 102 and used as a source of information to generate an electronic check or electronic promissory payment, wherein generation of the electronic check may be achieved using generally known electronic check conversion technology. Subsequently, the electronic check may then be submitted to the check approval agency or service 104 for authorization and settlement. As previously described, the electronic check or promissory payment identifies at least one of the customer's financial institution 116, transit number, routing number, branch number, account number, and the amount to be transferred as well as the merchant's financial institution 118, branch number, and account number. It should be appreciated that the electronic check, profile, pre-authorized check (PAC) item, or promissory payment may comprise additional identifying information without departing from the scope of the present teachings.

In one embodiment, this information may be acquired, inputted, read, scanned, or swiped from the paper drafted check using monetary exchange devices, such as check readers, image scanners, manual input of account information, keyed entry, or some combination thereof for the purpose of obtaining authorization for and settlement of financial transactions at the point of sale. Therefore, merchant based financial transaction systems may include various types of transaction devices and methods, which may include, for example, point of sale (POS) devices, display monitors, printers, scanners, and magnetic check readers. Further description relating to examples of transaction devices and methods is described in greater detail in the Applicant's co-pending U.S. patent applications entitled “Data Validation Systems and Methods for Use in Financial Transactions” U.S. patent application Ser. No. 10/671,000 (Attorney Docket Number 1DATA.043A) and “Data Validation Systems and Methods for Financial Transactions” U.S. patent application Ser. No. 10/671,001 (Attorney Docket Number 1DATA.095A), which is hereby incorporated by reference in its entirety. It should be appreciated by those skilled in the art that the acquisition of identification information should not be limited to transaction devices, but may further include various other generally known methods of gathering data and information.

For example, a paper drafted check may be presented by the customer 100 to the merchant 102 and scanned or swiped through a paper check reader. In one aspect, the check reader portion of the point of sale terminal identifies, by either magnetic ink character recognition (MICR) or optical character recognition (OCR), the customer's American Banking Association (ABA) routing and account information printed on the face of the paper drafted check. In addition, the check reader portion of the point of sale terminal also converts the customer's check information to an electronic check, which may include digital signals or digital signatures. Moreover, in one aspect, the electronic check may then be transferred from the transaction device to the check approval agency 104 for authorization, processing, and evaluation.

In some cases, a scanned or swiped image of the paper drafted check may be desirable for review by the check approval agency 104. In one aspect, scanned or swiped checks may prevent merchant error. In addition, the scanned or swiped image may include a digitized impression of the entire paper drafted check and/or points of interest on the paper drafted check, such as the check number, the banking institution's logo, and the customer's signature. It should be appreciated by one skilled in the art that the electronic check and/or the scanned image of the paper drafted check may be used to re-create the paper drafted check for settlement of payment through the paper check component 113 of the clearing house 110, such as the FCH or ACH.

After receiving the electronic check, which may also be referred to as an electronic profile or PAC item of the financial transaction, from the merchant 102, the check approval agency 104 uses the electronic profile to electronically send the transaction information to the electronic check component 112 of the clearing house 110. This information is then used by the clearing house 110 to instruct the customer's financial institution 116 to transfer the appropriate amount of finds from the customer's account in the customer's financial institution 116 to the merchant 102 via, for example, the merchant's financial institution 118.

Since problems with electronic checks may arise in some financial transactions, the check approval agency 104, in one aspect, may utilize a special rules database 106 to identify account numbers, branch numbers, On-Us transactions, and financial transactions where conventional routing of electronic checks may be rejected by the clearing house 110. Thus, when a new electronic check comes in on an identified account, branch, or financial transaction, the check approval agency 104 may utilize an alternative check resolution strategy, which may be referred to as an alternate to conventional electronic check conversion, to settle the payment in the financial transaction. In one aspect, the alternative check resolution strategy may utilize at least one of a plurality of special rules to settle financial transactions. Additionally, special rules may include, but are not limited to, submitting the electronic check to a different account or branch of the same financial institution for them to resolve 112, dropping the electronic check directly to a paper draft 113 (drop-to-draft), or utilizing a direct electronic access system 114. Moreover, it should be appreciated that dropping the electronic check to a paper draft may include a pre-authorized check or PAC item for submission to the clearing house 110 for payment settlement.

Another concern for the check approval agency 104 is developing the previously mentioned special rules that may be applied to problematic account numbers, branch numbers, and financial transactions. Once problems are identified, the check approval agency 104 utilizes the administrative component 107 to research reasons for transaction rejections so as to develop the previously mentioned alternative check resolution strategies for payment settlement. For some customers and certain situations, the drop-to-draft payment procedure may be more efficient than any other method available. In which case, the special rules database 106 may indicate immediate drop-to-draft as a special rule for a particular customer or financial transaction. Additionally, the administrative component may be adapted to develop an alternative resolution strategy by, for example, contacting financial institutions associated with the customer and/or merchant so as to identify alternate routing mechanisms for transferring monetary funds. Various other alternative resolution strategies may also include at least one of reviewing conversion mistakes, reviewing electronic profile mistakes, re-reading MICR for mistakes, noting funds payable via indicated financial institution, noting funds payable via an On-Us transaction, contacting check presenter, contacting check issuer, contacting the customer, contacting the merchant, examining images related to the financial transaction, pattern matching between images. It should be appreciated that further scope and functionality related to alternative resolution strategies and the development thereof will be described in greater detail herein below.

Advantageously, a special rule or pre-recorded special rule of immediate drop-to-draft in particular situations increases operational efficiency of the check approval agency 104 by substantially reducing the need for additional research or submission of payment trial and error processing. Furthermore, preprocessing of financial transactions using the special rules database 106 may be utilized to determine which electronic checks or profiles to print, in a drop-to-draft manner, so as to bypass likely clearing house 110 rejections.

Alternatively, a special rule or pre-determined special rule may include the use of the direct electronic access system 114 to settle payment in financial transactions. For example, the check approval agency 104 may submit the electronic check or profile to the direct electronic access system 114 along with a request for an exchange of monetary funds from the customer's account to the merchant. In this particular situation, the check approval agency 104 may choose to send an electronic request to the customer's financial institution 116, via a designated electronic network as described above, to transfer monetary funds from customer's identified account in the customer's financial institution 116 to the merchant via, for example, the merchant's financial institution 118.

In some situations, a special rule or pre-determined special rule may also include the utilization of a different account number and/or different branch number of the customer's financial institution 116 to settle payment in financial transactions. Sometimes, transaction information provided with the electronic check may not be recognized by the clearing house 110 in a manner as previously described. In this particular situation, the check approval agency 104 may discover through research that an alternative account number and/or alternative branch routing number may be used in place of the account or branch numbers received with the electronic check. Therefore, the alternative account and/or routing numbers may be used to settle payment in a more efficient manner.

In other situations, a special rule or pre-determined special rule may also include the utilization of an On-Us transaction, wherein settlement of the payment may take place in the same financial institution or different financial institutions depending on the relationship that the check approval agency or service 104 has with the financial institution. In this particular situation, the check approval agency 104 may discover through special rules that the customer's financial institution 116 is with a financial institution in which the check approval agency 104 has a direct connect relationship. Therefore, this information may be used by the check approval agency 104 to settle payment in a more efficient manner.

In still other situations, the check approval agency 104 may decline the financial transaction altogether due to unresolvable rejections associated with using the previously mentioned alternative check resolution strategies. Additionally, the administration component 107 may communicate directly with relevant financial institutions including the clearing house 110, the direct electronic access system 114, the customer financial institution 116, and/or the merchant's financial institution 188 in a manner so as to resolve rejections. The administration component 107 including development of special rules will be described in greater detail herein below.

As is known in the art, the paper check component 113 of the clearing house 110 may utilize generally known traditional paper check handling procedures to settle transactions between financial institutions. In addition, the electronic check component 112 of the clearing house 110 may utilize conventional electronic check handling procedures to accomplish the same. In this implementation, however, if an electronic check is returned to the check approval agency 104, for various reasons as described above, by the clearing house 110 or the customer's financial institution 116, then the check approval agency 104 may use an alternative resolution strategy.

These alternative resolution strategies may include re-creating a paper drafted check from the electronic check and submitting the paper drafted check to the clearing house 110 via the paper check component 113 thereof for subsequent settlement of the payment using traditional paper check handling procedures. The alternative resolution strategies may further include a situation where the check approval agency 104 submits the electronic check via the electronic check component 112 of the clearing house 110 using an alternative account number designated by either the customer 100, the customer's financial institution 116, or a particular branch of the customer's financial institution 116 for payment settlement. Alternative resolution strategies may also include pattern matching, or other means without contacting the consumer or the consumers FI.

Alternatively, the check approval service 104 may also utilize the direct electronic access system 114, which coordinates the electronic transfer of funds between financial institutions as an alternative resolution strategy. In one aspect, the direct electronic access system 114 may comprise an existing communication network, such as a secured internet connection or the generally known STAR™ financial network. The check approval agency 104 utilizes the direct electronic access system 114 to submit requests for monetary fund transfers from one account to another on behalf of the merchant 102. For example, the check approval agency 104 may choose to send an electronic request to a financial institution, such as the customer's financial institution 116, via the designated electronic network to transfer monetary funds from an identified account to another account

In one aspect, monetary fund transfers may take place in the same financial institution. As is generally known, this may be referred to as an On-Us transaction, wherein the customer and merchant belong to the same financial institution and such transactions are posted internally to the appropriate accounts. It should be appreciated that On-Us transactions may take place in different financial institutions depending on the relationship between the check approval agency 104 and the financial institutions involved with the financial transaction. For example, the merchant may exist in the same financial institution as the customer's account, and the funds may be easily transferred by the financial institution from the customer's account to the merchant. Or else, the monetary fund transfers may take place between different financial institutions such that the merchant may not exist in the same financial institution as the customer and the funds will transfer through the clearing house 110 in a generally known manner. Alternately, the transaction may take place between different financial institutions such that the check approval agency 104 coordinates the transfer of monetary funds directly with the financial institutions involved in the financial transaction so as to bypass the clearing house 110. Otherwise, the check approval agency 104 may temporally hold the monetary funds during exchange. For example, the merchant may not exist in the same financial institution as the customer's account and the funds will be initially routed to an account associated with the check approval agency 104 and then the check approval agency 104 will subsequently send the funds to the merchant via, for example, the merchant's financial institution 118.

In one aspect, On-Us means that the check approval agency or service 104, such as TeleCheck™, may have a relationship with one or more financial institutions in which the check approval agency or service 104 can send transactions directly to the financial institutions and bypass the clearing house 110, such as the ACH or Federal reserve, altogether. For example, the check approval agency or service 104 can utilize a financial institution, such as Bank One and Chase, as an originating depository financial institution (ODFI). In some instances, the check approval agency or service 104 can remove Bank One and Chase routing transit numbers from the normal clearing house 110 file and send these transactions directly to Bank One and Chase, respectively. Thus, it may not matter if the customer 100 and/or merchant 102 have the same financial institution, just that these transactions belong to Bank One and/or Chase. Further, it may not matter if it is a customer or merchant account, just that it is held at Bank One, Chase, and/or any financial institution that the check approval agency or service 104 has a direct connect relationship with.

Unfortunately, without the use of the special rules database 106, the check approval agency 104 may not know in advance whether the accounts exist in the same financial institution or how to efficiently process monetary fund transfers to avoid delays and/or likely rejections by the clearing house 110, such as the FCH or ACH. In addition, the check approval agency 104 may not know in advance whether to use the electronic check component 112, the paper check component 113, or the direct electronic access system 114 for settling payment in financial transactions. Advantageously, the special rules database 106 provides the check approval agency 104 with prior knowledge of problematic customers, financial institution accounts, financial institution branches, and financial transactions.

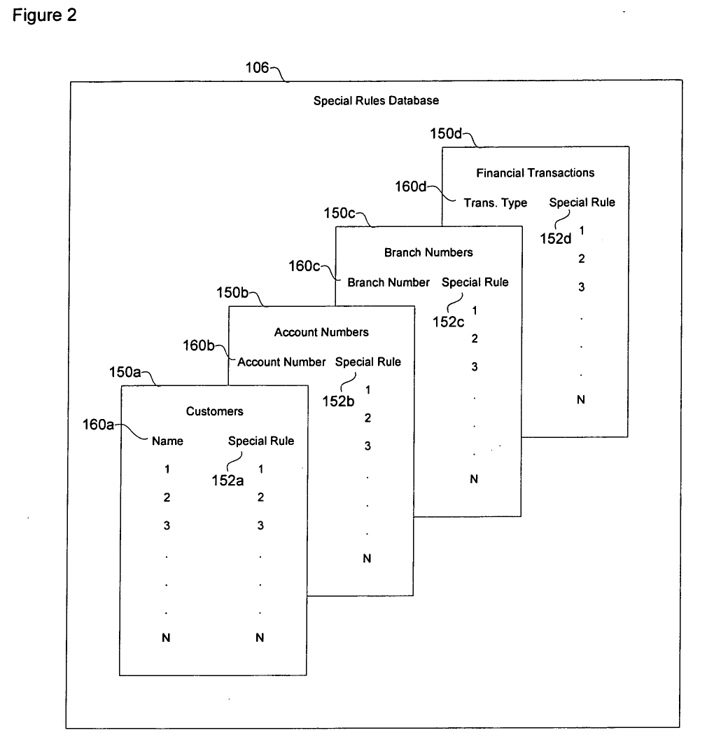

It should be appreciated that the success of the check approval agency 104, including profitability, may significantly depend on the efficient managing and routing of electronic payments between financial institutions. Advantageously, the check approval agency 104 utilizes the special rules database 106 to increase routing efficiency through the above-mentioned financial institutions in a manner so as to avoid re-routing of electronic payments for settlement. The scope and functionality of the special rules database 106 will be described in greater detail herein below with reference to FIG. 2.

As further illustrated in FIG. 1, the check approval agency 104 may also include the processing component 108. In one embodiment, the processing component 108 may be configured to electronically receive, for example, the electronic checks and process the electronic checks prior to authorization of the financial transaction. Additionally, the processing component 108 may be utilized by the check approval agency 104 to evaluate transaction information in a manner so as to coordinate evaluation processes of the received transaction profiles with the special rules database 106 so as to determine the most efficient routing of the monetary funds between financial institutions. For example, after receiving an electronic check or transaction profile from the merchant 102, the processing component 108 may search the special rules database 106 for transaction identification information, such as a customer name, routing number, account number, branch number, On-Us transaction, etc. If one or more matching parameters are located, then a corresponding special rule may be retrieved and applied to the financial transaction in a manner that will be described in greater detail herein below with reference to FIG. 2.

In general, it will be appreciated that the transaction processing component 108 may comprise, by way of example, computers, program logic, or other substrate configurations representing data and instructions, which operate as described herein. In other embodiments, the transaction processing component 108 may comprise controller circuitry, processor circuitry, processors, general purpose single-chip or multi-chip microprocessors, digital signal processors, embedded microprocessors, microcontrollers and the like. Additionally, it will be appreciated that in one embodiment, the program logic may advantageously be implemented as one or more components, wherein the components may advantageously be configured to execute on one or more processors. The components may include, but are not limited to, software or hardware components, modules such as software modules, object-oriented software components, class components and task components, processes methods, functions, attributes, procedures, subroutines, segments of program code, drivers, firmware, micro-code, circuitry, data, databases, data structures, tables, arrays, and variables.

FIG. 2 illustrates one embodiment of a special rules database 106. The special rules database 106 may comprise a plurality of lists 150a, 150b, 150c, 150d. Each list 150a, 150b, 150c, 150d corresponds to a plurality of records 160a, 160b, 160c, 160d associated with problematic customers 150a, financial institution accounts 150b, financial institution branches 150c, and financial transactions 150b. The records 160a, 160b, 160c, 160d may comprise a plurality of input fields or parameters from 1 to N and reference input fields that may be indexed by the particular list 150a, 150b, 150c, 150.

For example, a first set of records 160a in the customer list 150a correspond to a first set of special rules 152a, a second set of records 160b in the financial institution account list 150b correspond to a second set of special rules 152b, a third set of records 160a in the financial institution branch list 150c correspond to a third set of special rules 152c, and a fourth set of records 160d in the financial transaction list 120d correspond to a fourth set of special rules 152d. Therefore, when a particular list is accessed to identify and locate a particular record, the corresponding special rule may be retrieved.

As previously described, the special rules 152a, 152b, 152c, 152d may comprise at least one of submitting the electronic check to a different account or branch of the same financial institution for them to resolve, dropping the electronic check directly to a paper draft, using the direct electronic access system for payment settlement, and declining the financial transaction if rejections cannot be resolved. It should be appreciated that, depending on the needs of the merchant and/or the check approval agency, additional special rules may be developed and added to the special rules database by one skilled in the art without departing from the scope of the present teachings.

Additionally, the special rules database 106 may comprise the functionality to dynamically update records 160a, 160b, 160c, 160d in a manner so as to reflect recent financial transactions. For example, a first customer indicated by record 160a has at least one corresponding first special rule 152a that suggests a drop-to-draft procedure due a previously rejected routing number by a first bank. A second customer of record initiates a financial transaction with a merchant, and the corresponding second special rule indicates that a secondary routing number with the first financial institution should be used instead of the second routing number of record. Since the first and second customer use the same first bank, the special rules database 106 may be configured to update the first special rule to include the use of the secondary routing number indicated by the second special rule of record. Advantageously, the special rules database 106 dynamically updated the first special rule of record when the second customer's financial transaction cleared using the secondary routing number. It should be appreciated that other entities 150 and records 160 of the special rules database 106 may be dynamically updated in a similar manner as described with reference to FIG. 2 without departing from the scope of the present teachings.

In one aspect, the special rules database 106 may be implemented using applications designed for relational database development and implementation, such as, for example, those sold by Oracle Corporation or Sybase Corporation. Using the aforementioned database development software packages, the special rules database 106 may be implemented using a dedicated database language, such as, structured query language (SQL). The structured query language is a language standardized by the International Standards Organization (ISO) for defining, updating, and querying a relational database. The SQL coded database design may provide the developers of the special rules database 106 with a highly refined instruction set with properties of reduced maintenance requirements and increased scalability.

In another aspect, the special rules database 106 may comprise a database design implemented using numerous other programming languages such as, for example, JAVA, C/C++, Basic, Fortran, or the like, wherein the database structure, tables, and associations are defined by code of the programming languages. It should be appreciated however, that these languages may also be utilized to develop applications and programs for accessing and/or manipulating the aforementioned SQL coded database design. For example, the SQL coded database may interact with various accessory programs or servlets developed in other programming languages which provide graphical user interfaces to store, retrieve, and process the information of the special rules database 106.

It is further recognized that other relational databases may be used and/or other types of databases may be used, such as, for example, object oriented databases, flat file databases, and so forth. Moreover, the special rules database 106 may be implemented as spreadsheet or a single database with separate tables or as other data structures that are well known in the art such as linked lists, binary trees, and so forth. Additionally, the special rules database 106 may be implemented as a plurality of databases which are collectively administered.

It should also be appreciated by those of skill in the art, that in the aforementioned special rules database 106 designs, the structure and schema of the special rules database 106 may be altered, as needed, to implement the relations or associations utilized to organize and categorize the information contained in the special rules database 106. Furthermore, the database schema may be altered for numerous reasons, such as, for example, to accommodate new data types, change existing data structures representing existing data types, modify relations between existing data structures, and add new databases to the special rules database 106 without departing from the scope of the present teachings.

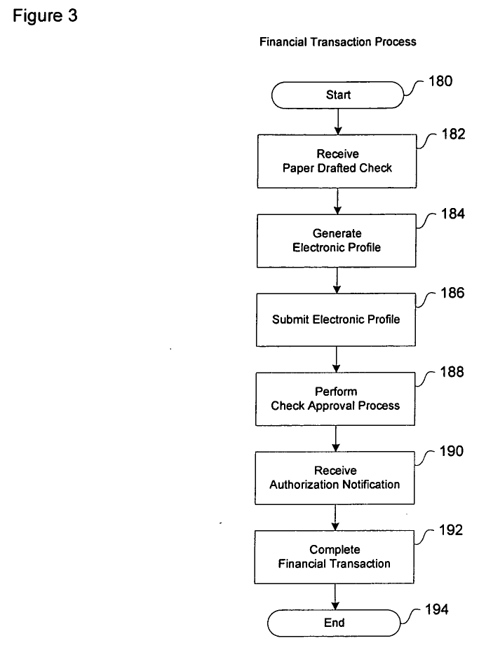

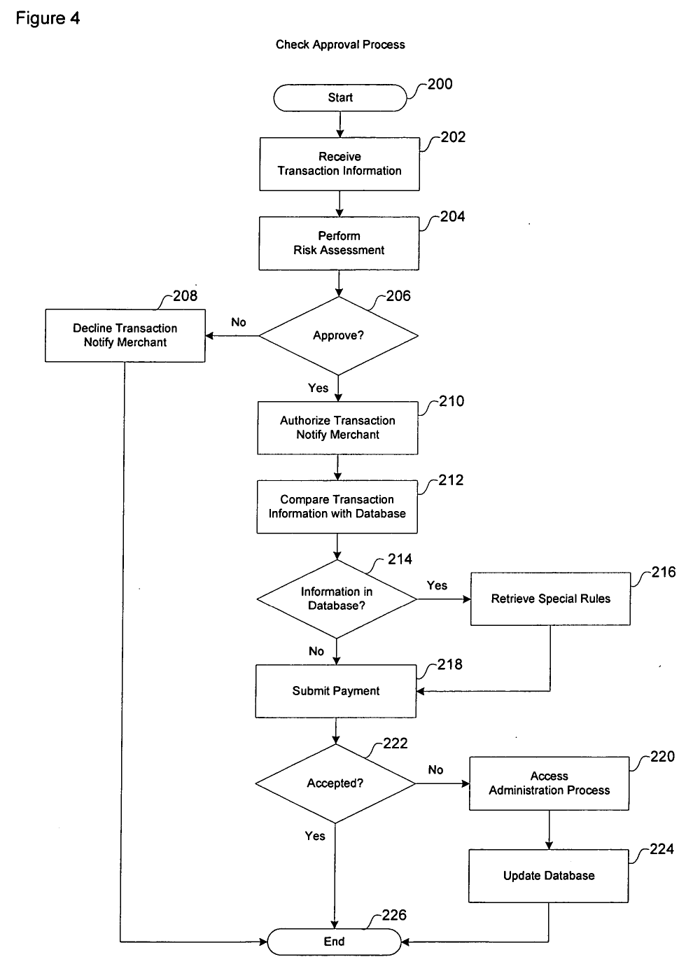

FIG. 3 illustrates one embodiment of a financial transaction process that describes the process of generating an electronic profile. The financial transaction process may involve accessing a check approval process in a manner as will be described in reference to FIG. 4 and using the special rules database 106 to settle the financial transaction through a clearing process in a manner as will also be described in greater detail herein below.

The financial transaction process initiates in a start state 180 and proceeds to a state 182. In the state 182, as previously mentioned with respect to FIG. 1, one or more financial transactions may involve a merchant 102 receiving a paper drafted check from a customer 100 in exchange for goods and/or services. Once the paper drafted check is received in a state 182, the financial transaction process advances to a state 184, where the merchant 102 uses the paper drafted check as source information to generate an electronic profile relating to the customer 100 and the financial transaction. The merchant 102 may run the paper drafted check through a transaction device, such as a MICR reader, to generate the electronic profile. In one aspect, the merchant 102 may use a computing device, such as a personal computer (PC), in combination with a transaction device to generate the electronic profile or may even scan the paper drafted check so as to generate image or impression of the paper drafted check. As a result, additional information relating to the financial transaction, such as merchant identification information and payment amount, will be included with the electronic profile.

Next, the financial transaction process advances to a state 186. In the state 186, the electronic profile is submitted to a subscription service, such as the check approval agency 104 described in FIG. 1. The electronic profile may be submitted electronically to the check approval agency 104 via, in one embodiment, the transaction device, which may be connected to the internet, an asynchronous transfer mode (ATM) terminal, a telephone system, wireless modem, or other various electronic mechanisms of transit without departing from the scope of the present teachings. Following submission of the electronic profile in the state 186, the financial transaction process proceeds to a state 188 to access the check approval process of FIG. 4, which will be described in greater detail herein below. Subsequently, in a state 190, the merchant 102 receives authorization notification in the form of an approval or decline status: Based on the authorization notification in the state 190, the financial transaction is completed in a state 192 and the financial transaction process terminates in an end state 194. It should be appreciated that the above described sequence of events illustrates one embodiment of the financial transaction process. Therefore, the above described sequence of events may vary without departing from the scope of the present teachings.

FIG. 4 illustrates one embodiment of a check approval process that functionally describes an alternative check resolution strategy that can be used by the check approval agency 104 in situations where conventional electronic check conversion fails to work. In one aspect, the check approval process may be utilized to efficiently route the exchange of monetary funds for a given financial transaction between the merchant 102 and the customer 100. In addition, the check approval agency 104 may utilize the special rules database 106 to identify customers, account numbers, routing numbers, branch numbers, On-Us transactions, or those financial transactions in which the electronic check component 112 of the clearing house 110, such as the FCH or ACH, is likely to reject the financial transaction.

As previously described, the alternative resolution strategy may comprise dropping the electronic check directly to paper draft, submitting electronically to a different branch of the same financial institution for them to resolve, submitting the electronic check to a financial institution as an On-Us transaction, or using the direct electronic access system as described above. Advantageously, special rules may be applied to particular customers, account numbers, and financial transactions for efficient and appropriate transfer of monetary funds between financial institutions in a manner as will be described below.

The check approval process initiates in a start state 200 and proceeds to a state 202. In the state 202, the check approval agency 104 obtains transaction data, information, and other details relating to the financial transaction from the merchant 102, in one embodiment, via the above-mentioned transaction device. In one embodiment, information relating to the financial transaction is obtained from the customer 100 and the merchant 102 in the form of electronic data relating to MICR information scanned or swiped from a paper drafted check so that the customer's financial institution, branch number, account number, amount to be transferred as well as the merchant's financial institution, branch number, and account number may be identified. As previously described, the paper drafted check may be used as source for transaction information to generate or produce an electronic profile at the point of sale and then transferred to the check approval agency 104 in the form of electronic data or information for processing and authorization of the financial transaction. In addition, the electronic profile may also be used identify whether the transaction includes an On-Us transaction. Moreover, it should be appreciated by those skilled in the art that a paper drafted check may be physically sent to the check approval agency 104 for electronic check conversion processing without departing from the scope of the present teachings.

Next, in a state 204 that follows, the check approval agency 104 may or may not pre-process the transaction information by generating a risk assessment score for the requested financial transaction in a manner as described in the Applicant's co-pending U.S. patent applications entitled “Systems and Methods for Selective Use of Databases to Predict Financial Risk” Ser. No. ______ Attorney Docket Number 1DATA.044A, “Systems and Methods for Selective Use of Risk Models to Predict Financial Risk” Ser. No. ______ Attorney Docket Number 1DATA.045A, and “Systems and Methods for Selectively Delaying Financial Transactions” Ser. No. ______ Attorney Docket Number 1DATA.047A. Once the risk assessment is performed and the risk score is generated in the state 204, the check approval process advances to a decision state 206, where the check approval agency 104 determines and evaluates the degree of the generated risk score. It should be appreciated that risk assessment is optional and may or may not affect the status of the special rules established for a particular customer 100.

In the decision state 206, if the check approval agency 104 determines from the comparison that the financial transaction is of high risk, then the check approval process advances to a state 208 to decline the financial transaction. It should be appreciated that the high risk assessment corresponding to the customer 100 and the financial transaction may lead to a decline decision status in the state 208 without further action by the check approval agency 104. Next, the check approval process terminates in a following end state 226.

Alternatively, in the decision state 206, the check approval agency 104 may approve the financial transaction, wherein, if the check approval agency 104 determines that the financial transaction is of low risk, then the check approval process advances to a state 210 to approve the financial transaction. In the state 210, the check approval agency 104 may authorize the financial transaction and notify the merchant 102 with an applicable result.

Following merchant authorization of the financial transaction in the state 210, the check approval process advances to a state 212. In the state 212, the check approval agency 104 may compare the received transaction information with the information of record stored in the special rules database 106 using, for example, in one embodiment, the processing component 108. Additionally, in the state 212, the special rules database 106 may be utilized as a preprocessing search mechanism for cross-referencing name entities, route number entities, account number entities, check number entities, On-Us transaction entities, and special rule entities in a manner as previously described with reference to FIG. 2.

The special rules 152 may comprise various handling procedures including, but not limited to, the use of the electronic check processing 152a, the use of the drop-to-draft processing 152b, the use of the alternate routing numbers 152c, and/or the use of the direct electronic access routing number 152d. In one aspect, the drop-to-draft procedure may include preprocessing techniques that determine which checks, electronic or otherwise, to print as paper drafted checks so as to bypass likely clearing house 110 rejections during fund transfer between financial institutions. In addition, an On-Us procedure may include preprocessing techniques that determine which checks, electronic or otherwise, to submit as On-Us transactions so as to bypass the clearing house 110 during fund transfer and exchange within financial institutions. In addition, the On-Us procedure may also include sending the check and clearing the transaction directly to the On-Us financial institution for processing and settlement. The clearing house 110 may include, for example, the Federal Clearing House (FCH) or Automated Clearing House (ACH).

Advantageously, the check approval process as described herein identifies customers, customer accounts, customer banks, merchants, merchant banks, and financial transactions that may require alternative check resolution strategies, wherein applying special rules to particular financial transactions substantially avoids re-routing of conventional electronic checks when likely clearing house 110 rejections may occur. Thus, utilization of the special rules database improves transaction efficiency by using prior knowledge of customer and merchant transaction information to settle electronic payments.

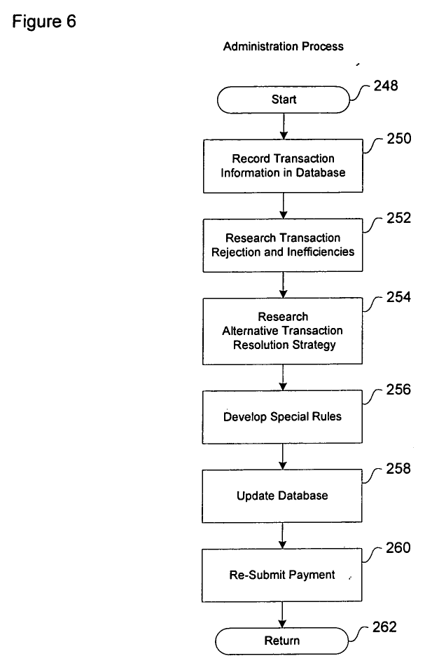

In a state 214, if one or more searched records 160 are found to match, such that the customer, account number, and/or branch number is identified, then the associated special rule record 160 may be accessed and retrieved in a state 216 for proper submission of payment and/or routing of funds in a state 218. The scope of the special rule retrieval process will be described in greater detail herein below with reference to FIG. 6.

Advantageously, the retrieved special rule may be applied to the particular financial transaction in a manner so as to efficiently route the transfer of funds through the network of financial institutions as illustrated in FIG. 1. As a result of retrieving the special rule, the efficient transfer of funds promotes substantially faster closing, balancing, and settlement of financial transactions. Otherwise, in the state 214, if one or more searched records 160 are found not to match or the customer is not identifiable, then the check approval process may advance directly to the state 218 to submit the request for payment.

In the state 218, the payment may be first submitted to the clearing house 110, such as the FCH or ACH, in an electronic manner 112. Subsequent to the state 218, an acceptance or rejection status of the submission of payment and/or routing of funds may be determined in a state 222. If, in a state 222, the request for payment is accepted, There is no accept in the ACH, just a reject. then the transaction may be considered complete and check approval process terminates in the end state 226. If the payment is rejected for administrative return reason codes, then the check approval process advances to the state 220 to access the administration process. In one aspect, the administrative process may be used to record the transaction information and develop one or more special rules regarding the financial transaction and/or relating to the customer. In another aspect, the administrative process may be utilized to resolve problems with routing funds and/or submitting payments to financial entities in a manner so as to determine reasons for rejection or non-acceptance. In still another aspect, the administration process may be utilized to identify which transactions, electronic or otherwise, can be submitted as On-Us transactions so as to bypass the clearing house 110 and settle transactions directly with or internally within financial institutions. In this situation, the transaction may be sent directly to the On-Us financial institution for processing and settlement. The scope and functionality of the administrative process will be described in greater detail herein below with reference to FIG. 6.

After performing the administration process in the state 220, the check approval process advances to the state 224, where the special rules database 106 may be updated by recording the acceptance or rejection status of the financial transaction. After updating the special rules database in the state 224, the check approval process terminates in the following end state 226.

Advantageously, the above-mentioned check approval process represents a significant improvement over traditional check handling procedures. The above-mentioned check approval process substantially avoids likely clearing house rejections by preprocessing financial transactions to determine efficient routing of funds and/or submission of payments by a customer via a merchant. In one aspect, special rules may be applied to recorded and/or known customers for efficient and appropriate transfer of funds between a network of financial entities. Also, retrieved special rules may be applied to current and future financial transactions in a manner so as to utilize prior knowledge of proper routing methods of recorded customers for efficient transfer of funds between financial entities, which promotes substantially faster closing, balancing, and settlement of financial transactions.

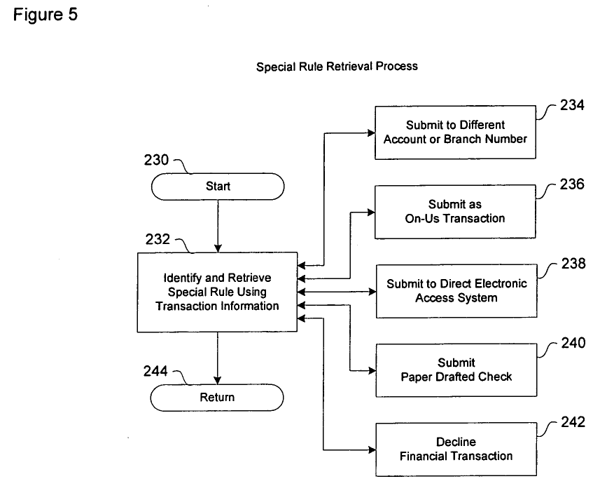

FIG. 5 illustrates one embodiment of a special rules retrieval process that may be used by the check approval agency 104 to identify and retrieve one or more special rules from the special rules database 106. FIG. 5 also illustrates a plurality of special rules that may be applied by the check approval agency 104 to financial transactions.

As illustrated in FIG. 5, the special rules retrieval process initiates in a start state 230 and proceeds to a state 232. As previously described, the processing component 108 of the check approval agency 104 uses the transaction information from the received electronic check or profile to cross-reference customer names, account numbers, branch numbers, On-Us transactions, etc. with the information stored in the lists 150a, 150b, 150c, 150d of the special rules database 106. In the state 232, the processing component 108 searches the 150a, 150b, 150c, 150d to identify a match. If a match is identified, then the corresponding special rule 152a, 152b, 152c, 152d is retrieved.

The retrieved special rules may include, but are not limited to, submitting the received electronic check to a different account or branch number 234 of the same financial institution for them to resolve, submitting the electronic check to a financial institution as an On-Us transaction 236 for settlement, submitting payment via the direct electronic access system 238, dropping the electronic check directly to a paper draft 240 for submission through the clearing house 110, or declining the financial transaction 242 if known that the submission of payment will be rejected using the submission methods 234, 236, 238, 240. In addition, it should be appreciated that the special rules shown in FIG. 5 are illustrative of a number of possible special rules that may be applied to the financial transaction. However, additional alternative resolution strategies including those as described herein may be employed without departing from the scope of the present teachings. Furthermore, once the special rule is identified and retrieved in the state 232, the special rule retrieval process advances to a state 244 and returns to the check approval process of FIG. 4.

Advantageously, the special rule retrieval process as described herein uses received transaction information to identify problematic customers, account numbers, branch numbers, etc.—so as to retrieve at least one corresponding special rule. As previously described, applying special rules to particular financial transactions substantially avoids re-routing of conventional electronic checks when likely clearing house 110 rejections may occur. Advantageously, utilization of the special rules database 106, as described herein, improves transaction efficiency by using prior knowledge of customer and merchant transaction information to settle electronic payments.

FIG. 6 illustrates one embodiment of an administration process that may be utilized by the check approval agency 104 to track problematic customer's, account numbers, branch numbers, etc. and develop one or more special rules associated with the problematic customers, account numbers, branch numbers, etc. In addition, the administrative process may also be utilized to resolve problems with routing funds and/or submitting payments to financial institutions in a manner so as to determine reasons for rejection or non-acceptance by the previously mentioned financial institutions including the clearing house 110, such as the FCH or ACH. Moreover, the administration process may be utilized to identify financial transactions that can be submitted as On-Us transactions so as to bypass the clearing house 110 and settle transactions internally within financial institutions. In this situation, an On-Us procedure may include sending the financial transaction directly to the On-Us financial institution for processing and settlement.

The administration process initiates in a start state 248 and then proceeds to a state 250. In state 250, the received electronic profile relating to the financial transaction, including but not limited to the customer's name, at least one routing number associated with the customer's financial institution, the customer's account number, and the customer's check number may be stored in the special rules database 106 for preprocessing. For example, problematic customers may be entered into the customer list 150a as a first record 160a so as to establish a special rule for future financial transactions involving the problematic customer. One purpose of establishing customer based records includes keeping an identifiable and relational log of past and current financial transactions so that future financial transactions may be handled in a more efficient manner with respect to the development of special rules relating to specific needs of a particular customer.

Once the received electronic check, profile, and/or transaction information is stored in the special rules database 106, the administration process advances to a state 252, where the reasons for transaction rejection or inefficiencies by one or more of the previously mentioned financial institutions may be researched. Reasons for rejection or inefficiency may include erroneous transaction information, wherein the information provided in the electronic check is not recognizable or identifiable. For example, the indicated financial institution or branch may not be recognized by the electronic check component 112 of the clearing house 110. In which case, the electronic check may need to be submitted to a different branch for settlement. In another example, the indicated financial institution may not be equipped to accept electronic checks or payments. In which case, the check acceptance agency 104 may then re-create or generate a paper check from the electronic check or profile, and submit the paper drafted check to the paper component 113 of the clearing house 110. In many instances, the paper created check may ultimately clear as the customer's financial institution 116 may recognize the paper check and process it appropriately.

Additionally, in state 252, the check approval agency 104 may also utilize the administration process to determine or identify transaction inefficiencies. For example, an electronic check or profile that can be settled between a customer and merchant within the same financial institution may then be submitted as an On-Us transaction to the financial institution so as to improve efficiency of payment or settlement. Thus, a special rule can be documented for future financial transactions.

Once the reasons for rejection and/or inefficiency are determined in the state 252, an alternative transaction resolution strategy may then be researched in a state 254. Various research methods may include contacting by, for example, telephone, mail, and/or the internet the previously mentioned financial institutions to determine the most efficient routing of funds between financial institutions. For example, if the electronic check or payment needs to be submitted to a different branch for settlement, then the different branch may be contacted to determine if the electronic check can be submitted. In addition, if the indicated financial institution is not equipped to accept electronic checks or payments, then the indicated financial institution may be contacted to verify the account and routing numbers so that a paper drafted check may be properly created and submitted to the paper component 113 of the clearing house 110 or directly to the financial institution.

It should be appreciated that methods of research may also include submitting payments to one or more of the above-mentioned financial institutions to determine the most efficient routing of the funds. If rejections or inefficiencies with certain financial institutions arise, then the rejections or inefficiencies may be recorded in the special rules database. In addition, it should also be appreciated by one skilled in the art that various other research methods may be used to determine the most efficient routing of funds without departing from the scope of the present teachings.

After researching alternative transaction resolution strategies in the state 254, one or more special rules may be developed from the researched alternative transaction resolution strategy in state 256. In one aspect, it should be appreciated that many, but not all, instances of transaction rejections or inefficiencies fall under the special rules 234, 236, 238, 240, 242 as described in FIG. 5. For example, if submitting the received electronic check to a different account or branch number 234 of the same financial institution resolves the rejection, then that special rule 234 is applied to that situation. If submitting an electronic check can be accomplished via an On-Us transaction so as to improve efficiency, then the special rule 236 may be applied to that situation. If submitting payment via the direct electronic access system 238 resolves the rejection, then that special rule 238 is applied to that situation. Additionally, if dropping the electronic check directly to a paper draft 240 for submission through the clearing house 110 resolves the rejection, then that special rule 240 is applied to that situation. Moreover, if declining the financial transaction 242 because the rejection cannot be resolved using the other submission methods 234, 236, 238, 240, then that special rule 242 is applied to that situation. After the special rule is developed and applied to the particular customer, banking account, banking branch, etc. in state 256, the administration process advances to state 258 to update the special rules database 106 by storing the developed special rule 152a, 152b, 152c, 152d in the appropriate list 150a, 150b, 150c, 150d next to the appropriate record 160a, 160b, 160c, 160d.

Following, in state 260, funds may be re-routed and/or the payment may be re-submitted according to the researched alternative transaction resolution strategy and developed special rule. If, after re-submission of the payment and/or re-routing of funds, the financial transaction is accepted in the state 260, then the administration process returns in state 262 to the check approval process of FIG. 4. In some cases, if the financial transaction remains unapproved in the state 260, then the check approval agency or service 104 may perform additional processing of the financial transaction information, including further transaction rejection or inefficiency research. If additional processing is deemed necessary, then the processing is performed and the payment is re-submitted a second time. Otherwise, if the additional processing cannot resolve the rejection or inefficiency, then the check approval agency 104 may decline the transaction altogether and record this information in the special rules database 106 so that future transactions involving this customer, merchant, financial institution account, etc. will be declined. Subsequently, in state 262, the administration process returns to the check approval process of FIG. 4.

Advantageously, the administration process may be utilized to improved cash flow for the merchant 102 and/or the check approval agency 104 through faster closing/balancing and settlement of financial transactions. Financial transactions utilizing the special rules database 106 benefit, in one aspect, from more efficient transit or routing of funds through the clearing process. For example, the above-mentioned check approval process and administration process utilizes an efficient and selective mechanism for evaluating appropriate routing of funds in the network of financial institutions. If rejection or inefficient situations arise, the above-mentioned check approval process and administration process selectively and dynamically corrects rejection and inefficient related problems by determining the most efficient routing of monetary funds possible. As a result, financial transactions may be completed, balanced, and settled in a more competent manner such that the customer may be less inconvenienced, the merchant may increase sales, and the check approval agency may reduce the potential loss of monetary funds.

Although the following description exemplifies one embodiment of the present teachings, it should be understood that various omissions, substitutions, and changes in the form of the detail of the apparatus, system, and/or method as illustrated as well as the uses thereof, may be made by those skilled in the art, without departing from the spirit of the present teachings. Consequently, the scope of the present teachings should not be limited to the disclosed embodiments, but should be defined by the appended claims.

What is claimed is:

1. A method of processing electronic promissory payments made by a customer to a merchant, the method comprising:
receiving an electronic representation of a promissory payment that includes an identification of the customer account and the merchant;
determining whether the payment can be submitted for subscriber settlement by evaluating a special rules database to determine whether the customer's transactions are subject to a special rule;
submitting the payment to the customer's financial institution electronically if it is determined that the customer's electronic representation is not subject to a special rule; and
submitting the payment to the customer's financial institution according to the special rule if it is determined that the customer's electronic representation is subject to a special rule.

2. The method of claim 1, wherein evaluating the special rules database includes identifying the customer's financial institution associated with at least one of an account number, a routing number, and an alternative routing number.

3. The method of claim 1, wherein evaluating the special rules database includes determining if the special rule comprises printing the electronic representation of the payment as a paper drafted check for submission to the clearing house.

4. The method of claim 3, wherein submitting the payment to the customer's financial institution includes submitting the paper drafted check to the customer's financial institution.

5. The method of claim 3, wherein submitting the payment to the customer's financial institution includes submitting a pre-authorized check or PAC item.

6. The method of claim 1, wherein evaluating the special rules database includes determining if the special rule comprises submitting the electronic representation of the payment to the customer's financial institution via a direct electronic access system.

7. The method of claim 6, wherein submitting the payment to the customer's financial institution includes submitting the electronic representation of the payment to the customer's financial institution via the direct electronic access system.

8. The method of claim 1, wherein evaluating the special rules database includes determining if the special rule comprises the use of an alternative routing transit number.

9. The method of claim 8, wherein submitting the payment includes submitting the payment to the customer's financial institution using the alternative routing transit number.

10. The method of claim 1, wherein evaluating the special rules database includes determining if the special rule comprises the use of an alternative account number.

11. The method of claim 10, wherein submitting the payment includes submitting the payment to the customer's financial institution using the alternative account number.

12. The method of claim 1, wherein receiving electronic promissory payments comprises generating an electronic profile relating to the customer using electronic check conversion.

13. The method of claim 1, wherein submitting the customer's electronic representation to the customer's financial institution comprises transferring funds from the customer's account using electronic fund transfer.

14. The method of claim 1, wherein submitting the customer's electronic representation to the customer's financial institution directly comprises transferring funds from the customer's account direct connect, On-Us processing.

15. The method of claim 1, wherein the method further comprises performing a risk assessment relating to processing electronic promissory payments using the electronic representations of the promissory payments.

16. The method of claim 1, wherein the method further comprises updating the special rules database in a manner so as to record previous submissions by the customer.

17. A method of settling a financial transaction between a customer and a merchant using a routing mechanism, the method comprising:
acquiring an electronic profile relating to the customer, wherein the electronic profile can be used to transfer funds from the customer's financial institution;
evaluating the electronic profile using a special rules database having previously stored electronic information relating to the customer in a manner so as to identify a special rule; and
requesting settlement of the financial transaction with the customer's financial institution using at least one of the electronic profile and the special rule, wherein the special rule identifies the manner in which the finds can be transferred from the customer's financial institution.

18. The method of claim 17, wherein identifying the special rule includes identifying that the financial transaction requires printing of a paper drafted check.

19. The method of claim 18, wherein printing the paper drafted check includes printing a drop-to-draft check.

20. The method of claim 19, wherein requesting settlement of the financial transaction comprises submitting the printed paper drafted check to the clearing house to settle the financial transaction.

21. The method of claim 17, wherein identifying the special rule includes identifying that the financial transaction requires the use of a direct electronic access system.

22. The method of claim 21, wherein requesting settlement of the financial transaction comprises submitting the electronic profile to the customer's financial institution using the direct electronic access system.

23. The method of claim 17, wherein evaluating the special rules database includes evaluating pre-recorded electronic information relating to either the customer or the customer's financial institution.

24. The method of claim 23, wherein evaluating the pre-recorded information comprises evaluating a previous check writing history relating to either the customer or the customer's financial institution.

25. The method of claim 17, wherein identifying the special rule comprises identifying either the customer or the customer's financial institution associated with at least one of an account number, a routing number, and an alternative routing number.

26. The method of claim 17, wherein the method further comprises generating a risk score indicative of the risk associated with the financial transaction.

27. The method of claim 17, wherein the method further comprises updating the special rules database in a manner so as to record previous electronic profiles relating the customer.

28. The method of claim 17, wherein evaluating the electronic profile further comprises developing at least one special rule relating to at least the customer.

29. A system for resolving an electronic check transaction to transfer money from a customer's financial institution via an existing funds transfer entity in response to the customer providing a promissory payment to a merchant, the system comprising:
a transaction device which receives a promissory payment from the customer to the merchant, wherein the transaction device generates and transmits an electronic profile indicative of the promissory payment and routing information; and
a check approval service that has access to records of past electronic check transactions that receives the electronic profile, wherein the check approval service identifies an electronic route for obtaining access to the customer's account and either (i) submits the electronic profile to the existing funds transfer entity electronically for electronic transfer of the funds from the customer's account, or (ii) initiates an alternative resolution strategy prior to submitting the electronic profile to the existing funds transfer entity electronically if the records of past electronic check transactions indicates that an electronic check transaction for the received electronic profile may not be successful.

30. The system of claim 29, wherein the check approval service submits the electronic profile to the existing finds transfer entity electronically by submitting the electronic profile to an electronic check conversion entity of a federal banking clearing house.

31. The system of claim 29, wherein the check approval service includes a special rules data base that contains identifiers identifying electronic profiles for which electronic check transaction may not be successful.

32. The system of claim 31, wherein the special rules data structure includes indicators of alternative resolution strategies that will result in successful transfer of funds from the customer's account in response to the check approval service receiving the electronic profile.

33. The system of claim 32, wherein the alternative resolution strategies include:
printing a paper representation of the electronic profile and submitting the paper representation to an existing paper clearing house so as to initiate the transfer of money from the customer's financial institution;
changing the routing information of the electronic profile so as to identify a new route for obtaining access to the customer's account and submitting the changed electronic profile to the existing funds transfer entity electronically; and
submitting the electronic profile to the customer's financial institution via an alternative funds transfer entity.

34. The system of claim 33, the check approval service changes the routing information to identify a new financial institution associated with the customer's financial institution that will receive and process the electronic profile.

35. The system of claim 33, wherein the check approval service submits the electronic profile via an alternative funds transfer entity by submitting the electronic profile directly to the customer's financial institution bypassing the existing funds transfer entity.

36. The system of claim 29, wherein the check approval service includes an administrative component that when an electronic profile is submitted to the existing funds transfer entity electronically and the submission does not result in the transfer of funds from the customer's account, and wherein the administrative component attempts to develop an alternative resolution strategy that will result in subsequent transfer of funds for similar transactions.

37. The system of claim 36, wherein the administrative component tracks the customer, if the records of past electronic check transactions indicates that an electronic check transaction for the received electronic profile may not be successful, by storing the customer's electronic profile in a customer list so as to develop the alternative resolution strategy for future financial transactions involving the customer.

38. The system of claim 36, wherein the administrative component develops the alternative resolution strategy by contacting financial institutions associated with the customer's account so as to identify alternate routing mechanisms for transferring funds from the customer's account.

39. The system of claim 36, wherein developing the alternative resolution strategy includes reviewing the electronic profile for mistakes, reviewing the electronic profile for pattern matching, reviewing an image of the electronic profile, settlement via On-Us transaction, contacting the customer, and contacting the merchant, contacting the financial institution.

40. The system of claim 36, wherein the alternate routing strategy includes the use of at least one of an alternate account routing number, an alternate routing number, a paper clearing house routing system, a direct electronic access routing system for transferring funds from the customer's account.

41. The system of claim 36, wherein the administration component records the developed alternative resolution strategy in a retrievable manner so that the developed alternative resolution strategy can be used in future transactions involving the customer.

42. The system of claim 36, wherein the administration component re-submits the electronic profile using the developed alternative resolution strategy to determine if similar transactions involving the customer will result in subsequent transfer of funds.

43. A method for resolving an electronic check transaction to transfer money from a customer's financial institution via an existing funds transfer entity in response to the customer providing a promissory payment, the method comprising:
receiving a promissory payment from the customer;
generating an electronic profile indicative of the promissory payment;
transmitting the electronic profile;
accessing records of past electronic check transactions;
identifying routing information for obtaining access to the customer's account;
submitting the electronic profile to the existing funds transfer entity electronically for electronic transfer of funds from the customer's financial institution if it is determined that the records of past electronic check transactions indicates that an electronic check transaction for the received electronic profile will be successful; and
initiating an alternative resolution strategy prior to submitting the electronic profile to the existing funds transfer entity electronically if it is determined that the records of past electronic check transactions indicates that an electronic check transaction for the received electronic profile may not be successful.

44. The method of claim 43, wherein submitting the electronic profile to the existing funds transfer entity electronically includes submitting the electronic profile to an electronic check conversion entity of a federal banking clearing house.

45. The method of claim 43, wherein the method further comprises identifying electronic profiles for which electronic check transaction may not be successful.

46. The method of claim 45, wherein identifying electronic profiles includes identifying alternative resolution strategies that will result in successful transfer of funds from the customer's account in response to receiving the electronic profile.

47. The method of claim 46, wherein identifying alternative resolution strategies include at least one of:
printing a paper representation of the electronic profile and submitting the paper representation to an existing paper clearing house so as to initiate the transfer of money from the customer's account;
changing the account information of the electronic profile so as to identify a new account number for obtaining access to the customer's account and submitting the changed electronic profile to the existing funds transfer entity electronically;
changing the routing information of the electronic profile so as to identify a new route for obtaining access to the customer's account and submitting the changed electronic profile to the existing funds transfer entity electronically; and
submitting the electronic profile to the customer's financial institution via an alternative funds transfer entity.

48. The method of claim 47, the method further comprises changing the routing information to identify a new financial institution branch associated with the customer's financial institution that will receive and process the electronic profile.

49. The method of claim 47, wherein submitting the electronic profile via an alternative funds transfer entity includes submitting the electronic profile directly to the customer's financial institution bypassing the existing funds transfer entity.

50. The method of claim 43, wherein the method further comprises developing an alternative resolution strategy that will result in subsequent transfer of funds for similar transactions if submitting the electronic profile to the existing funds transfer entity does not result in the transfer of funds from the customer's account.

51. The method of claim 50, wherein the method further comprises tracking the customer's transactions, if the records of past electronic check transactions indicates that an electronic check transaction for the received electronic profile may not be successful, by storing the customer's electronic profile in a customer list so as to develop the alternative resolution strategy for future financial transactions involving the customer.

52. The method of claim 50, wherein developing the alternative resolution strategy includes contacting financial institutions associated with the customer's account so as to identify alternate routing mechanisms for transferring funds from the customer's account.

53. The method of claim 52, wherein identifying alternate routing mechanisms includes identifying at least one of an alternate account routing number, an alternate branch routing number, a paper clearing house routing system, and a direct electronic access routing system.

54. The method of claim 50, wherein the method further comprises recording the developed alternative resolution strategy in a retrievable manner so that the developed alternative resolution strategy can be used in future transactions involving the customer.

55. The method of claim 50, wherein the method further comprises re-submitting the electronic profile using the developed alternative resolution strategy to determine if similar transactions involving the customer will result in subsequent transfer of funds.
